(19) United States
(12) Patent Application Publication
(10) Pub. No.: US 2026/0253514 A1
(43) Pub. Date: Aug. 27, 2026

(54) BAND TO ENCIRCLE A WEARER AND METHODS FOR MAKING SAME

(71) Applicant: MEDIREX SYSTEMS INC., Toronto (CA)

(72) Inventor: Steve NOWAK, Niagara Falls (CA)

(21) Appl. No.: 19/064,451

(22) Filed: Feb. 26, 2025

(51) Int. Cl. G09F 3/00; B32B 7/06; B32B 7/12; B32B 27/08; B32B 27/32; B32B 27/36; G09F 3/02; G09F 3/10

(52) U.S. Cl. CPC G09F 3/005; B32B 7/06; B32B 7/12; B32B 27/08; B32B 27/32; B32B 27/36; G09F 3/02; G09F 3/10; B32B 2250/03; B32B 2250/24; G09F 2003/0257

(57) ABSTRACT

According to an aspect, there is provided a band configured to encircle a portion of a wearer and methods for making same. The band including an outer layer configured for direct thermal printing, a middle layer configured to be an adhesive layer, and an inner layer comprising a peelable portion which, once removed, exposes the middle layer. The inner layer is laminated to the outer layer with the middle layer there between.

### FIELD

Embodiments of the present disclosure generally relate to bands for wearers and more specifically to improved hospital wristbands for patient safety and/or identification.

### INTRODUCTION

Wristbands can be used in hospital settings for patient safety and/or identification. These wristbands need to be capable of having information (e.g., identification information) printed or otherwise provided thereon. Furthermore, these wristbands need to be easily prepared and donned on a patient, but difficult to remove to ensure the wristbands to do not inadvertently become detached. Wristbands for some patients (e.g., babies) may require special care in their construction to ensure the wristband cannot be worn down by the patient (e.g., chewed through or dissolved by saliva) to ensure that they do not become a hazard to the patient.

Wristbands, such as those used in hospitals, can be made using direct thermal materials which allow the application of information onto the wristband using direct thermal printing. Direct thermal wristbands (e.g., for hospitals) are manufactured using specialized equipment such as narrow-width label presses equipped with glue tab applicators. These wristbands are made from a single type of raw material, often coated polypropylene or synthetic paper. These wristbands are often shaped using a set of dies mounted to a narrow width press and at the end of the press a glue tab for fastening is applied using a glue tab applicator. This process requires significant expertise and specialized machinery, making it costly and complex.

Improvement in the field of wristbands is desirable.

### SUMMARY

The present invention relates to direct thermal bands (e.g., wristbands for use in a hospital and designed to provide patient identification and/or medical information). The bands described herein can be constructed using laminated materials to enhance durability and comfort, while simplifying the manufacturing process. The bands described herein can simplify the manufacturing process by using a laminated raw material composed of multiple layers, each with specific properties.

The laminated material can consist of a coated outer layer for high-quality thermal printing, durability, and chemical resistance, an adhesive middle layer that maintains adhesion under various conditions, and an inner layer providing comfort and resistance to skin irritation. Each layer of the raw material can provide a specific set of features needed to manufacture a direct thermal hospital wristband.

The laminated material can be converted into a band by die cutting through one of the layers of the laminated material to access the middle adhesive layer. This approach can eliminate the need for specialized label presses and glue tab applicators and obviate the need for a glue tab application step. This can simplify the manufacturing process and reduce the total cost associated with producing the bands.

According to an aspect, there is provided a band configured to encircle a portion of a wearer. The band including an outer layer configured for direct thermal printing, a middle layer configured to be an adhesive layer, and an inner layer comprising a peelable portion which, once removed, exposes the middle layer. The inner layer is laminated to the outer layer with the middle layer there between.

In some embodiments, the outer layer includes polypropylene.

In some embodiments, the middle layer includes a marine-grade adhesive.

In some embodiments, the inner layer includes polyester.

In some embodiments, the inner layer is laminated onto the outer layer at about 250° F. for about 30 s at about 80 PSI.

In some embodiments, the outer layer coated with at least one of a chemical layer receptive to thermal printing and a UV coating.

In some embodiments, the band further includes a narrow border along the edge of the band including the inner layer.

In some embodiments, the band is die cut into shape and the inner layer is die cut with an incision to provide a peelable portion.

In some embodiments, the band is configured to encircle at least one of a wrist, an arm, an ankle, and a leg of the wearer.

In some embodiments, the band is a hospital wristband.

According to an aspect, there is provided a method of manufacturing a band configured to encircle a portion of a wearer. The method includes coating an outer layer with an adhesive, laminating an inner layer to the outer layer to form a three-layered laminated material, wherein the adhesive makes up a middle layer, die cutting the three-layered laminated material into a band.

In some embodiments, the outer layer includes polypropylene.

In some embodiments, the middle layer includes a marine-grade adhesive.

In some embodiments, the inner layer includes polyester.

In some embodiments, laminating the inner layer includes laminating the inner layer onto the outer layer at about 250° F. for about 30 s at about 80 PSI.

In some embodiments, the method further includes at least one of applying a chemical layer receptive to thermal printing to the outer layer and UV coating the outer layer.

In some embodiments, die cutting leaves a narrow border of the inner layer along the edge of the band.

In some embodiments, die cutting the three-layered laminated material includes incising the inner layer to provide a peelable portion.

In some embodiments, the band is configured to encircle at least one of a wrist, an arm, an ankle, and a leg of the wearer.

In some embodiments, the band is a hospital wristband.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1A shows a cross-sectional side view of a three-layered laminated material, according to some embodiments.

FIG. 1B shows a cross-sectional perspective view of a three-layered laminated material with a chemical layer and a UV-coating, according to some embodiments.

FIG. 2 shows a process diagram of a method of manufacturing bands, according to embodiments described herein.

FIG. 3A shows a plan view of the outer layer of a sheet of laminated material that has been cut into bands, according to some embodiments.

FIG. 3B shows a plan view of the inner layer of a sheet of laminated material that has been cut into bands, according to some embodiments.

FIG. 4A shows a perspective view of multiple rolled rows of bands yet to be sliced into individual rows, according to some embodiments.

FIG. 4B shows a perspective view of a rolled row of bands after being sliced into an individual row, according to some embodiments.

FIG. 5A shows a plan view of the outer layer of a band, according to some embodiments.

FIG. 5B shows a plan view of the inner layer of a band, according to some embodiments.

FIG. 6A shows the printing process of the laminated material, according to some embodiments.

FIG. 6B shows the die cut process of the laminated material, according to some embodiments.

FIG. 6C shows the removal of the matrix from the laminated material, according to some embodiments.

### DETAILED DESCRIPTION

Before any embodiments are explained in detail, it is to be understood that the disclosure is not limited in its application to the details of construction and the arrangement of components set forth in the following description or illustrated in the accompanying drawings. The disclosure is capable of other embodiments and of being practiced or of being carried out in various ways.

### Definitions

The term “substantially” as used herein may be applied to modify any quantitative representation which could permissibly vary without resulting in a change in the basic function to which it is related.

Terms such as “up to”, “at least”, “greater than”, “less than”, “more than”, “or more”, and the like, include the number recited and such terms refer to ranges that can be subsequently broken down into sub-ranges. In the same manner, all ratios recited herein also include all sub-ratios falling within the broader ratio.

The singular forms “a,” “an,” and “the” include the plural reference unless the context clearly dictates otherwise. The term “and/or” means any one of the items, any combination of the items, or all of the items with which this term is associated.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

The terms “inner” and “outer” when used to describe layer placement on a band are to be interpreted relative to a wearer's body when worn. For example, the “inner” layer may refer to the layer that will be proximate the wearer's body when worn and “outer” layer may refer to the layer that will be distal the wearer's body when worn.

### The Laminated Material

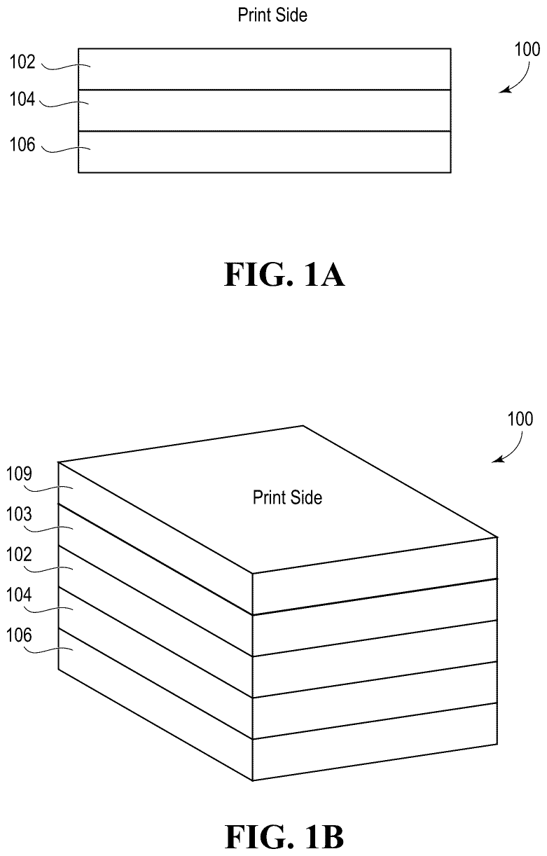

FIG. 1A shows a cross-sectional side view of a three-layered laminated material 100, according to some embodiments.

The bands described herein can be constructed from a three-layer laminated material 100. The three-layered laminated material 100 can be fabricated from an outer layer 102, a middle layer 104, and an inner layer 106. Each layer may provide functionality for the final product.

The outer layer 102 can be made of a material suitable for direct thermal printing. The outer layer 102 may be a material that is specially treated to be suitable for direct thermal printing. Information printed (e.g., direct thermally printed) on the outer layer 102 can remain legible and intact for the duration of the product's use (e.g., the lifetime of the wristband). The outer layer 102 can be durable, flexible, and resistant to chemical (e.g., cleaning and disinfecting liquids) and/or physical abuse. In some embodiments, the outer layer 102 can be fabricated from polypropylene. In some embodiments, derivatives and/or analogues of polypropylene can be used to make the outer layer 102. In some embodiments, the outer layer 102 can be between 1 mm and 5 mm in thickness.

The middle layer 104 can be an adhesive layer configured to maintain adhesion properties during use. Preferentially, the middle layer 104 can maintain its adhesion properties for, for example, up to fifteen days. Preferentially, the middle layer 104 can maintain adhesion even during/after exposure to bodily fluids, water (cold, hot, or lukewarm), alcohol, cleaning and disinfecting liquids, and/or body heat. The middle layer 104 can ensure that the final product (the band) remains securely fastened without requiring additional equipment or adhesives during application. In some embodiments, the middle layer 104 comprises a marine-grade adhesive. In some embodiments, the middle layer 104 can comprise a urethane polymer that includes distilled water, docusate sodium, and ethanol blended together.

The inner layer 106 is configured to be gentle for the skin of a wearer while maintaining its structural integrity. The inner layer 106 can provide a comfortable interface with a wearer's skin that can prevent irritation and maintain durability against chemical (e.g., cleaning and disinfecting liquids) and/or physical abuse. In some embodiments, the inner layer 106 comprises polyester. In some embodiments, the polyester comprises a food-grade polyester. In some embodiments, the inner layer 106 can have a thickness between 0.5 and 5 mm.

In some embodiments, one or more of the outer layer 102 and the inner layer 106 can comprise nylon taffeta and the middle layer 104 can comprise a pressure sensitive adhesive as described in U.S. patent application Ser. No. 14/396,661, titled “Patient Wristband”, filed on Oct. 23, 2014, published as US patent publication no. US 2015/0096211 A1 and now granted as U.S. Pat. No. 9,330,579 B2, the contents of which are incorporated herein by reference.

In some embodiments, the three-layered laminated material 100 can enable high-quality thermal printing thereon (so that printed information is legible and long lasting). In some embodiments, the three-layered laminated material 100 can provide flexibility that can ensure that any resulting wristbands can be used on wrists of various sizes. In some embodiments, wristbands made from the three-layered laminated material 100 can provide durable adhesion for secure fastening, resistance to chemicals (e.g., cleaning and disinfecting liquids), bodily fluids, and/or physical stress for up to, for example, fifteen days, and comfort with prolonged skin contact.

In some embodiments, the materials making up the three-layer laminated material 100 (and consequently the final band) can be selected to provide bacterial resistance. For example, using polypropylene in the outer layer 102, marine-grade adhesive in as the adhesive middle layer 104, and food-grade polyester as the inner layer 106 may provide bacterial resistance.

FIG. 1B shows a cross-sectional perspective view of a three-layered laminated material 100 with a chemical layer 103 and a UV-coating 109, according to some embodiments.

As described above, the outer layer 102 may be a material that is specially treated to be suitable for direct thermal printing. For example, the outer layer 102 may be treated with a chemical layer 103 such as bisphenol-A (BPA) or bisphenol-S (BPS) (shown as layer 103 on the outer layer 102) to make the outer layer 102 receptive to thermal printing.

In some embodiments, a UV-coating 109 is applied to the outer layer 102 (e.g., on the chemical layer 103 if one is provided). The UV-coating 109 can prevent any print that is thermally printed thereon from smudging or degrading for a number of days. The UV-coating 109 may also prevent any chemicals in the outer layer 102 or the chemical layer 103 (e.g., a chemical layer such as BPA or BPS) from being exposed to the wearer.

### Manufacturing Process

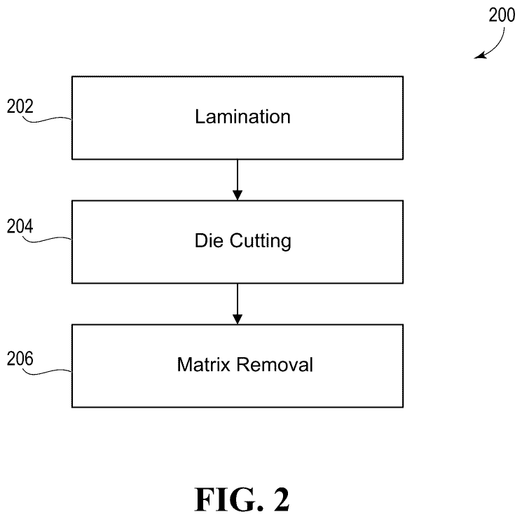

FIG. 2 shows a process diagram of a method 200 of manufacturing bands, according to embodiments described herein.

The method 200 includes the steps of laminating the outer layer 102 (which is coated with the middle layer 104) to the inner layer 106 to form the three-layered laminated material 100 (block 202), die cutting the three-layered laminated material 100 into shape (block 204), and removing matrix (block 206).

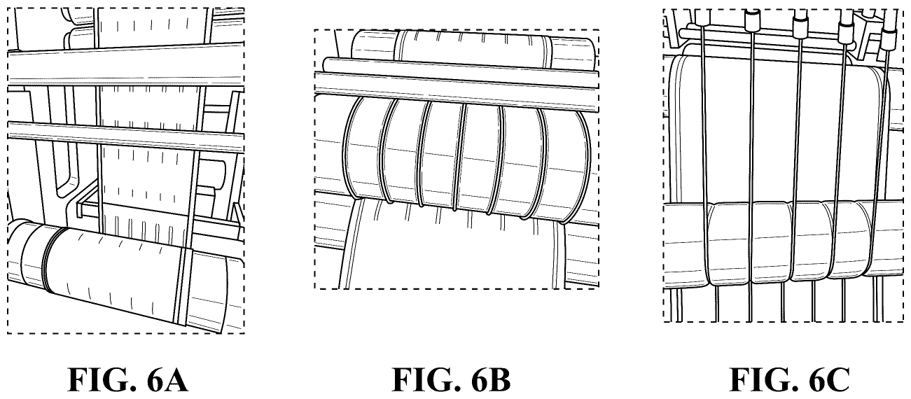

FIG. 6A shows the printing process of the laminated material 100, according to some embodiments. This step may occur before the lamination (block 202). This step may apply, for example, guides (e.g., guides to show where a peelable region is) or logos.

During lamination (block 202), the outer layer 102 (e.g., polypropylene) can be coated with the middle layer 104 (e.g., a marine-grade adhesive). The outer layer 102 is then laminated to the inner layer 106 (e.g., polyester). The lamination may, for example, take place at a temperature of about 250° F. for about 30 seconds under a pressure of about 80 PSI or other suitable conditions. This lamination process can create a strong bond between the layers, forming a durable and flexible three-layered material 100 suitable for, for example, bands. This lamination process can ensure that when someone attempts to remove the band, the band tears/separates to show that it's been tampered with (tamper evidence). The lamination process can also help the final band withstand high temperature variations and moisture, such as a shower, pool, whirlpool environments.

Because the method 200 does not apply an adhesive tab in a separate step, a better grade of adhesive (e.g., marine-grade glue) can be implemented in the bands. Specifically, because the lamination process (block 202) can take place at only about 250° F., a marine-grade adhesive can be used. This adhesive (e.g., the marine-grade glue) may be superior to those implemented in “hotmelt” applications that apply the adhesive tab.

Using better adhesive can aide the bands in staying affixed to the wearer for longer durations. This may reduce the frequency with which the bands need to be replaced. This may also avoid situations wherein the band comes off of a wearer and creates a dangerous situation. For example, bands with adhesives that can better withstand dissolution by saliva may not come off of an infant wearer's wrist as easily. This may ensure that the bands do not become choking hazards for infant wearers.

In some embodiments, the outer layer 102 can be coated with a chemical layer 103 and/or a UV-coating 109. The chemical layer 103 may be BPA or BPS to make the outer layer 102 receptive to thermal printing. Other chemical layers 103 are contemplated. The UV-coating 109 can be used to enhance the durability of the printed information and provide additional resistance to environmental factors. In some embodiments, the UV-coating 109 may be between 100-300 mm in thickness.

FIG. 6B shows the die cut process of the laminated material 100 (block 204), according to some embodiments.

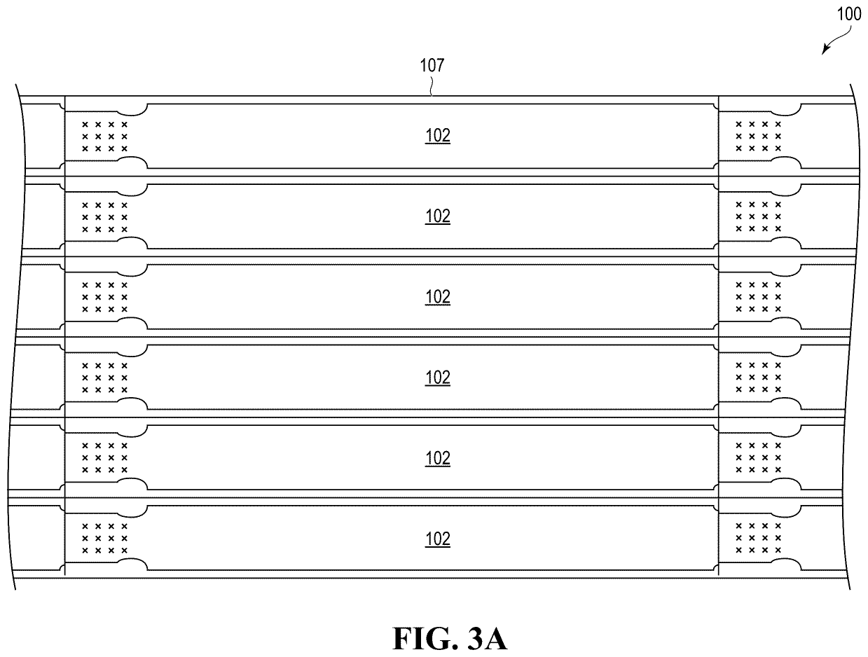

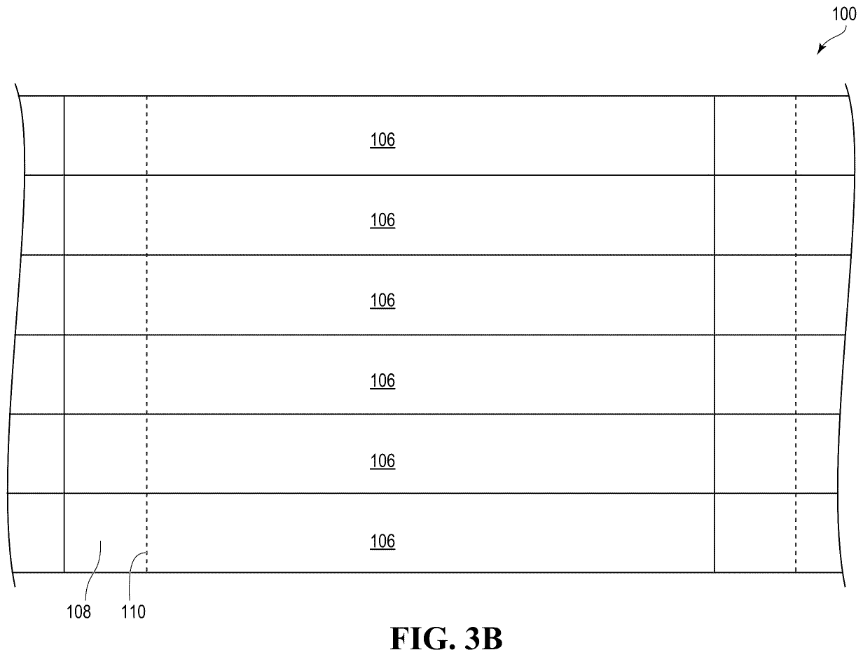

During die cutting (block 204), the three-layered laminated material 100 can be die cut into the shape of the final products (e.g., wristbands). FIG. 3A shows a plan view of the outer layer 102 of a sheet of laminated material 100 that has been cut into bands, according to some embodiments. FIG. 3B shows a plan view of the inner layer 106 of a sheet of laminated material 100 that has been cut into bands, according to some embodiments. In some embodiments, the die cut can cut the outer layer 102 (e.g., the polypropylene layer). When the outer layer 102 is removed, the adhesive middle layer 104 may also come off with the outer layer 102 leaving only the inner layer 106 (e.g., the polyester layer). The outer layer 102 may be cut away from the exterior of the band leaving a thin border 107 of the inner layer 106. In some embodiments, this narrow border is 0.5-2 mm wide. This thin border 107 may prevent the adhesive middle layer 104 from leaking into a thermal printer during the thermal printing process. This may reduce the frequency of printer breakdowns or reduce the amount of maintenance the printers require.

The die cut can also cut an incision 110 in inner layer 106 to provide a peelable portion 108 of the inner layer 106. The incision 110 may be a full incision, a scoring, or other method suitable to make a portion of the inner layer 106 more readily removable. In use, the peelable portion 108 can be peeled from the laminated material 100 exposing the adhesive middle layer 104 which can be adhered to the outer layer 102 at the other side of the band when encircling the wearer's, for example, wrist. The outer layer 102 can further be cut around a peelable portion 108 of the inner layer 106 to provide an easy mechanism for the user to pull at (see the circular cut 114 proximate to the incision 110). The die-cutting process can use precision tools to ensure that each wristband is identical and meets the required specifications.

FIG. 6C shows the removal of the matrix from the laminated material 100 (block 206), according to some embodiments.

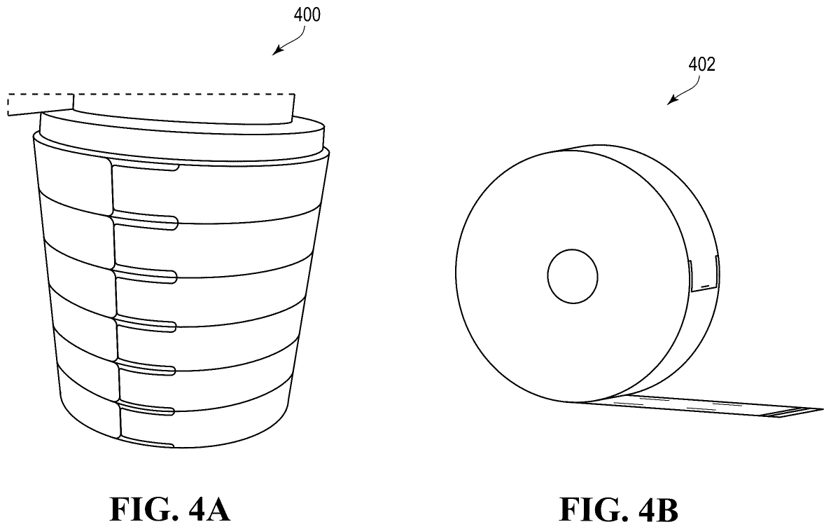

During matrix removal (block 206), the excess material (i.e., the cut away outer layer 102 and adhesive middle layer 104) is removed from the die-cut band, leaving only the band. In some embodiments, the three-layered laminated material 100 is cut into several rows of bands (e.g., wristbands) at once (see, e.g., the rolled rows of bands 400 in FIG. 4A). In such embodiments, the rows can be slit into individual tapes of bands (e.g., wristbands). The die-cut three-layered material 100 can be run through a standard label press process in which the matrix can be removed and die-cut three-layered material 100 slit into individual width rolls of bands. In some embodiments, the tape of bands can be rewound into rolls of the bands (e.g., into rolls of wristbands). The rewinding process can divide the tape of bands into rolls of the appropriate quantity (see, e.g., the single roll of bands 402 in FIG. 4B) on, for example, rewinding equipment. This can ensure that the bands are easy to handle and apply in a hospital setting.

According to an aspect, there is provided a method 200 of manufacturing a band 500 configured to encircle a portion of a wearer. The method 200 includes coating an outer layer 102 with an adhesive, laminating an inner layer 106 to the outer layer to form a three-layered laminated material 100 (block 202), wherein the adhesive makes up a middle layer 104, die cutting the three-layered laminated material 100 into a band 500 (block 204).

In some embodiments, the outer layer 102 includes polypropylene.

In some embodiments, the middle layer 104 includes a marine-grade adhesive.

In some embodiments, the inner layer 106 includes polyester.

In some embodiments, laminating the inner layer 106 (block 202) includes laminating the inner layer 106 onto the outer layer 102 at about 250° F. for about 30 s at about 80 PSI.

In some embodiments, the method 200 further includes at least one of applying a chemical layer 103 receptive to thermal printing to the outer layer 102 and UV coating 109 the outer layer 102.

In some embodiments, die cutting (block 204) leaves a narrow border 107 of the inner layer 106 along the edge of the band 500.

In some embodiments, die cutting the three-layered laminated material 100 includes incising the inner layer 106 to provide a peelable portion 108.

In some embodiments, the band 500 is configured to encircle at least one of a wrist, an arm, an ankle, and a leg of the wearer.

In some embodiments, the band 500 is a hospital wristband.

### Product in Use

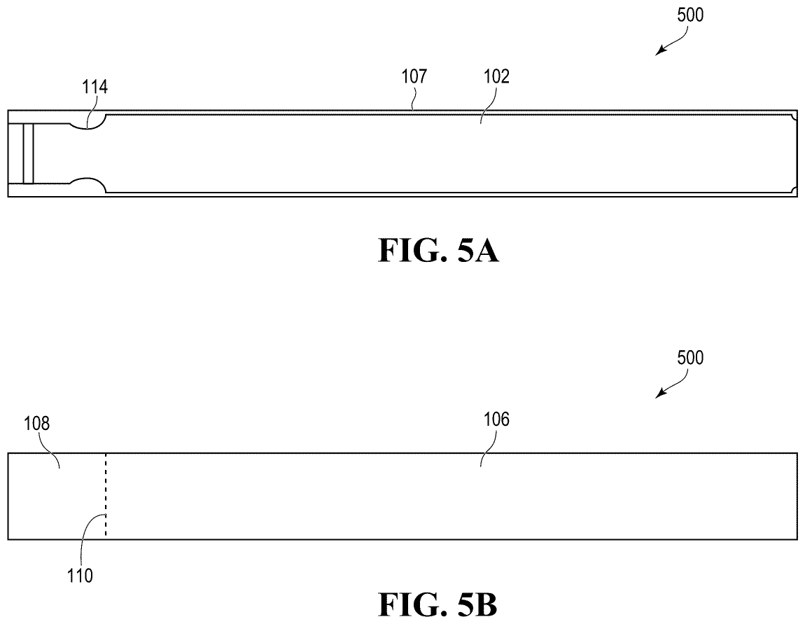

FIG. 5A shows a plan view of the outer layer 102 of a band 500 (e.g., a wristband), according to some embodiments.

FIG. 5B shows a plan view of the inner layer 106 of a band 500 (e.g., a wristband), according to some embodiments.

Once removed from the roll, the band 500 can have information printed thereon using, for example, a direct thermal printer. To apply the band 500 to the wearer, an adhesive portion of the band 500 can be exposed by peeling off the peelable region 108 of the inner layer 106 (e.g., by pulling at the circular cut 114). The band 500 can encircle a portion of the wearer (e.g., their wrist) and the exposed adhesive portion can be affixed to the opposite end 112 of the outer layer 102 to form a closed loop. The outer layer 102 facing outward from the wearer and the inner layer 106 facing towards the wearer.

According to an aspect, there is provided a band 500 configured to encircle a portion of a wearer. The band 500 including an outer layer 102 configured for direct thermal printing, a middle layer 104 configured to be an adhesive layer, and an inner layer 106 comprising a peelable portion 108 which, once removed, exposes the middle layer 104. The inner layer 106 is laminated to the outer layer 102 with the middle layer 104 there between.

In some embodiments, the outer layer 102 includes polypropylene.

In some embodiments, the middle layer 104 includes a marine-grade adhesive.

In some embodiments, the inner layer 106 includes polyester.

In some embodiments, the inner layer 106 is laminated onto the outer layer 102 at about 250° F. for about 30 s at about 80 PSI.

In some embodiments, the outer layer 102 coated with at least one of a chemical layer 103 receptive to thermal printing and a UV coating 109.

In some embodiments, the band 500 further includes a narrow border 107 along the edge of the band including the inner layer 106.

In some embodiments, the band 500 is die cut into shape and the inner layer 106 is die cut with an incision 110 to provide a peelable portion 108.

In some embodiments, the band 500 is configured to encircle at least one of a wrist, an arm, an ankle, and a leg of the wearer.

In some embodiments, the band 500 is a hospital wristband.

Producing a band (e.g., a direct thermal printed wristband for use in a hospital to identify and/or provide information on patients) as described herein may provide a simplified manufacturing process that can reduce the need for specialized equipment and skilled operators. This can reduce the overall cost of manufacturing the bands. Producing bands based on the methods described herein may also provide bands of enhanced durability which may remain functional and comfortable for up to, for example, fifteen days. The bands described herein may provide a substrate for high-quality thermal printing that may maintain legibility and information integrity. The manufacturing processes described herein may be cost-effective which may make the bands more accessible to hospitals and/or healthcare providers.

While the foregoing discussion has focussed on direct thermal printing wristbands for use in a hospital setting, other implementations are possible without deviating from the teachings described herein. For example, the band may be configured to encircle or otherwise secure to another portion of a wearer's body. For example, an armband, leg band, or ankle band are also capable of manufacture and use as described herein. Furthermore, the bands may find use in settings outside the hospital. For example, these may be useful in long-term care facilities or other institutional settings. The bands may find use in any variety of wristband intended for long-term wear (e.g., multiple days) by the wearer and/or where the band must withstand chemical (e.g., cleaning and disinfecting liquids) and/or physical abuse. For example, the bands may find use in disaster relief settings to identify victims or other settings wherein identification of individuals may be beneficial.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A band configured to encircle a portion of a wearer, the band comprising:
an outer layer configured for direct thermal printing;
a middle layer configured to be an adhesive layer; and
an inner layer comprising a peelable portion which, once removed, exposes the middle layer, wherein the inner layer is laminated to the outer layer with the middle layer there between.

2. The band of claim 1, further comprising a narrow border along the edge of the band comprising the inner layer.

3. The band of claim 1, wherein the inner layer is laminated onto the outer layer at about 250° F. for about 30 s at about 80 PSI.

4. The band of claim 1, wherein the outer layer is coated with at least one of a chemical layer receptive to thermal printing and a UV coating.

5. The band of claim 1, wherein the band is die cut into shape and the inner layer is die cut with an incision to provide a peelable portion.

6. The band of claim 1, wherein the band is configured to encircle at least one of a wrist, an arm, an ankle, and a leg of the wearer.

7. The band of claim 1, wherein the band is a hospital wristband.

8. A method of manufacturing a band configured to encircle a portion of a wearer, the method comprises:
coating an outer layer with an adhesive;
laminating an inner layer to the outer layer to form a three-layered laminated material, wherein the adhesive makes up a middle layer;
die cutting the three-layered laminated material into a band.

9. The method of claim 8, wherein die cutting leaves a narrow border of the inner layer along the edge of the band.

10. The method of claim 8, wherein laminating the inner layer comprises laminating the inner layer onto the outer layer at about 250° F. for about 30 s at about 80 PSI.

11. The method of claim 8, wherein the method further comprises at least one of applying a chemical layer receptive to thermal printing to the outer layer and UV coating the outer layer.

12. The method of claim 8, wherein die cutting the three-layered laminated material comprises incising the inner layer to provide a peelable portion.

13. The method of claim 8, wherein the band is configured to encircle at least one of a wrist, an arm, an ankle, and a leg of the wearer.

14. The method of claim 8, wherein the band is a hospital wristband.

15. A band configured to encircle a portion of a wearer, manufactured according to a method that comprises:
coating an outer layer with an adhesive;
laminating an inner layer to the outer layer to form a three-layered laminated material, wherein the adhesive makes up a middle layer;
die cutting the three-layered laminated material into a band.

16. The band of claim 15, wherein die cutting leaves a narrow border of the inner layer along the edge of the band.

17. The band of claim 15, wherein laminating the inner layer comprises laminating the inner layer onto the outer layer at about 250° F. for about 30 s at about 80 PSI.

18. The band of claim 15, wherein the method further comprises at least one of applying a chemical layer receptive to thermal printing to the outer layer and UV coating the outer layer.

19. The band of claim 15, wherein die cutting the three-layered laminated material comprises incising the inner layer to provide a peelable portion.

20. The band of claim 15, wherein the band is configured to encircle at least one of a wrist, an arm, an ankle, and a leg of the wearer.
